(19) United States
(12) Patent Application Publication
(10) Pub. No.: US 2025/0266880 A1
(43) Pub. Date: Aug. 21, 2025

(54) REPORTING PROCEDURE INFORMATION FOR SIMULTANEOUS MULTI-PANEL UPLINK TRANSMISSION

(71) Applicant: Nokia Technologies Oy, Espoo (FI)

(72) Inventors: Juha Pekka KARJALAINEN, Oulu (FI); Sami-Jukka HAKOLA, Kempele (FI); Timo KOSKELA, Oulu (FI); Mihai ENESCU, Espoo (FI)

(21) Appl. No.: 18/859,292

(22) PCT Filed: Apr. 29, 2022
(86) PCT No.: PCT/EP2022/061470

§ 371 Date: Oct. 23, 2024

(51) Int. Cl. H04B 7/06; H04L 5/00

(52) U.S. Cl. CPC H04B 7/0626; H04L 5/0048

(57) ABSTRACT

Mechanism on reporting procedure information for simultaneous multi-panel uplink (UL) transmission is provided. According to embodiments of the present disclosure, a first device transmits first capability information to a second device. The first capability information comprises a list of UE capability value sets. Each UE capability value set in the list defines an antenna arrangement of the first device and is characterized by a first number of transmission antenna ports. The first device transmits second capability information to the second device. The second capability information comprises a group of UE capability value sets, wherein the group of UE capability value sets defines a plurality of antenna arrangements of the first device, and coherence information in phase domain between transmission antenna ports of the plurality of antenna arrangements or between the plurality of antenna arrangements. In this way, it enables simultaneous multi-antenna panel codebook based UL transmission with different antenna panels having difference capabilities.

### FIELD

Embodiments of the present disclosure generally relate to communication techniques, and more particularly, to methods, devices and computer readable medium for reporting procedure information for simultaneous multi-panel uplink (UL) transmission.

### BACKGROUND

With developments of communication systems, new technologies have been proposed. A terminal device can be configured in different modes for physical uplink shared channel (PUSCH) multi-antenna precoding, namely codebook-based transmission and non-codebook-based transmission. In addition, a unified transmission configuration indicator (TCI) framework has been introduced, which means that TCI states so far providing quasi-colocation (QCL) assumptions for the reception of DL signals and channels would be used also to provide spatial sources for the transmission of UL signals and channels. So far, it has specified support for UL sounding reference signal (SRS) up to 4 transmitting (TX) antenna ports and lacks support for higher number of TX antenna ports. Enhanced UL peak data rates can enable short-range applications such as home entertainment, video surveillance/monitoring in industrial/healthcare/safety, integrated access and backhaul (IAB), and other applications where power/form-factor/cost with devices are not as stringent as in traditional handheld user equipment. To reduce difference between downlink (DL) and UL spectral efficiencies in NR, a building of specification support for simultaneous UL transmission with more than 4 TX antenna ports can be seen as attractive approach for both FR1 and FR2. Hence, there is strong need to develop methods and/or signalling solutions to overcome this problem.

### SUMMARY

Generally, embodiments of the present disclosure relate to a method for reporting procedure information for simultaneous multi-panel uplink (UL) transmission and corresponding devices.

In a first aspect, there is provided a first device. The first device comprises at least one processor; and at least one memory including computer program code: the at least one memory and the computer program cods are configured to, with the at least one processor, cause the first device to: transmit, to a second device, first capability information indicating a list of user equipment, UE, capability value sets, wherein each UE capability value set in the list defines (or identifies, or is associated with) an antenna arrangement of the first device and is characterized by a number (also referred to as the first number) of transmission antenna ports; and transmit, to the second device, second capability information indicating: a group of UE capability value sets, wherein the group of UE capability value sets defines (or identifies, or is associated with) a plurality of antenna arrangements of the first device, and coherence information in phase domain between transmission antenna ports of the plurality of antenna arrangements or between the plurality of antenna arrangements.

In a second aspect, there is provided a second device. The second device comprises at least one processor; and at least one memory including computer program code: the at least one memory and the computer program code are configured to, with the at least one processor, cause the second device to: receive, from a first device, first capability information indicating a list of user equipment, UE, capability value sets, wherein each UE capability value set in the list defines an antenna arrangement of the first device and is characterized by a first number of transmission antenna ports; and receive, from the first device, second capability information indicating: a group of UE capability value sets, wherein the group of UE capability value sets defines a plurality of antenna arrangements of the first device, and coherence information in phase domain between transmission antenna ports of the plurality of antenna arrangements or between the plurality of antenna arrangements.

In a third aspect, there is provided a method. The method comprises, at a first device, transmitting, to a second device, first capability information indicating a list of user equipment, UE, capability value sets, wherein each UE capability value set in the list defines an antenna arrangement of the first device and is characterized by a first number of transmission antenna ports; and transmitting, to the second device, second capability information indicating: a group of UE capability value sets, wherein the group of UE capability value sets defines a plurality of antenna arrangements of the first device, and coherence information in phase domain between transmission antenna ports of the plurality of antenna arrangements or between the plurality of antenna arrangements.

In a fourth aspect, there is provided a method. The method comprises, at a second device, receiving, from a first device, first capability information indicating a list of user equipment, UE, capability value sets, wherein each UE capability value set in the list defines an antenna arrangement of the first device and is characterized by a first number of transmission antenna ports; and receiving, from the first device, second capability information indicating: a group of UE capability value sets, wherein the group of UE capability value sets defines a plurality of antenna arrangements of the first device, and coherence information in phase domain between transmission antenna ports of the plurality of antenna arrangements or between the plurality of antenna arrangements.

In a fifth aspect, there is provided a first device. The first device comprises means for transmitting, to a second device, first capability information indicating a list of user equipment, UE, capability value sets, wherein each UE capability value set in the list defines an antenna arrangement of the first device and is characterized by a first number of transmission antenna ports; and means for transmitting, to the second device, second capability information indicating: a group of UE capability value sets, wherein the group of UE capability value sets defines a plurality of antenna arrangements of the first device, and coherence information in phase domain between transmission antenna ports of the plurality of antenna arrangements or between the plurality of antenna arrangements.

In a sixth aspect, there is provided a second device. The second device comprises means for receiving, from a first device, first capability information indicating a list of user equipment, UE, capability value sets, wherein each UE capability value set in the list defines an antenna arrangement of the first device and is characterized by a first number of transmission antenna ports; and receiving, from the first device, second capability information indicating: a group of UE capability value sets, wherein the group of UE capability value sets defines a plurality of antenna arrangements of the first device, and coherence information in phase domain between transmission antenna ports of the plurality of antenna arrangements or between the plurality of antenna arrangements.

In a seventh aspect, there is provided a computer readable medium comprising program instructions for causing an apparatus to perform at least the method according to the above third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a schematic diagram of a communication system according to embodiments of the present disclosure;

FIG. 2 illustrates a schematic diagram of antenna arrangements according to embodiments of the present disclosure:

FIG. 3 illustrates a schematic diagram of interactions between devices according to embodiments of the present disclosure;

FIGS. 4A and 4B illustrate schematic diagrams of antenna arrangements and resource allocations according to embodiments of the present disclosure:

FIG. 5 illustrates a flow chart of a method implemented at a first device according to some example embodiments of the present disclosure:

FIG. 6 illustrates a flow chart of a method at a second device according to some example embodiments of the present disclosure:

FIG. 7 illustrates a simplified block diagram of an apparatus that is suitable for implementing embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point, for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Regarding downlink beam indication, a quasi-colocation (QCL) indication functionality has been defined. The principle to receive certain physical signal or physical channel is: the UE is either configured with or the UE implicitly determines a source/reference signal (RS) that UE has received and measured earlier which defines how to set RX beam for the reception of the downlink (target) physical signal or channel to be received. To provide UE with QCL characteristics for the target signal (to be received) a Transmission Coordination Indication (TCI) framework has been defined by means of which UE can be configured TCI state(s) to provide UE with source RS(s) for determining QCL characteristics. Each TCI state includes one or two source RSs that provide UE QCL TypeA, TypeB, TypeC and/or TypeD parameters. Different types provide the parameters as follows: QCL-TypeA: {Doppler shift, Doppler spread, average delay, delay spread}; QCL-TypeB: {Doppler shift, Doppler spread}; QCL-TypeC: {Doppler shift, average delay}; QCL-TypeD: {Spatial Rx parameter}.

As mentioned above, a unified TCI framework has been introduced. For example, Release 17 has introduced a unified TCI framework meaning that TCI states so far providing quasi-colocation (QCL) assumptions for the reception of DL signals and channels would be used also to provide spatial sources for the transmission of UL signals and channels. Furthermore, the unified TCI framework defines the concept of indicated TCI state. The indicated TCI state can be joint DL and UL TCI state or separate DL and separate UL TCI states. Indicated TCI state provides QCL source (DL) and spatial source (UL) for the set of downlink signals and channels and for the set of uplink signals and channels, respectively. In Release 17 there can be one indicated joint DL and UL, or one indicated DL and one indicated UL TCI state for the UE. On the unified TCI framework, the following aspects have been clarified/agreed in RANI so far: Common TCI state (a.k.a. indicated TCI) for a set of signals and channels at a time: RRC configures set (or pool) of joint and/or separate TCI states: MAC activates a number (e.g. 8) of joint and/or separate TCI states; before first indication, first activated TCI state is the current indicated TCI state: DCI indicates one of the activated TCI states to be indicated TCI state (which may be a common TCI state). Thus, it is important to identify and specify necessary enhancements for uplink multi-input multi-output (MIMO), while necessary enhancements on downlink MIMO that facilitate the use of large antenna array, not only for FR1 but also for FR2, would still need to be introduced to fulfil the request for evolution of NR deployments.

On the DCI-based TCI state indication, the following has been agreed so far: regarding the DCI format, DCI format 1_1 or 1_2, with and without DL assignment, is used to carry the TCI state indication: regarding the acknowledgment of the TCI state indication, the indication is acknowledged/confirmed by the UE via HARQ ACK: regarding the application time of the beam indication, the first slot that is at least X ms or Y symbols after the last symbol of the acknowledgment of the joint or separate DL/UL beam indication: regarding the TCI field codepoint, there are two options: (1) joint: TCI state for both DL and UL, and (2) separate: a pair of DL TCI state and UL TCI state, a DL TCI state (keep the current UL TCI state), or an UL TCI state (keep the current DL TCI state). A fast UL panel/beam selection can be used for UL transmissions for a UE having two or more panels with different (or sometimes same) capabilities.

As mentioned above, UL transmission with more than 4 TX antenna ports (AP) is a useful method to bridge the gap between DL and UL spectral efficiency, in both frequency range FR1 and FR2. Especially, for FR2 operation or operation even with higher carrier frequencies, simultaneous multi-panel UL transmission with legacy codebook (up to 4 APs, and up to 4 layers) or new codebook (up to 8 APs, and up to 8 layers) can be seen as a key enabler to reduce the difference between DL and UL in spectral efficiency. Hence, there is strong need to develop methods and/or signaling solutions to overcome this problem. The following problem can be identified when UE is configured with UL SRS codebook based with simultaneous multi-antenna panel transmission associated with single or multiple TRPs. Conventional technologies provide support only for codebook-based UL transmission with single TX antenna panel with multiple antenna ports and it is not applicable with simultaneous use of multiple antenna panels for UL transmission.

In order to solve at least part of the above problems and other potential problems, solutions on reporting procedure information for simultaneous UL transmission are proposed. According to embodiments of the present disclosure, a first device transmits first capability information to a second device. The first capability information indicates a list of UE capability value sets. Each UE capability value set in the list defines an antenna arrangement of the first device and is characterized by a first number of transmission antenna ports. The first device transmits second capability information to the second device. The second capability information comprises a group of UE capability value sets. The group of UE capability value sets defines a plurality of antenna arrangements of the first device, and coherence information in phase domain between transmission antenna ports of the plurality of antenna arrangements or between the plurality of antenna arrangements. In this way, it enables simultaneous multi-antenna panel codebook based UL transmission with different antenna panel combinations having difference capabilities.

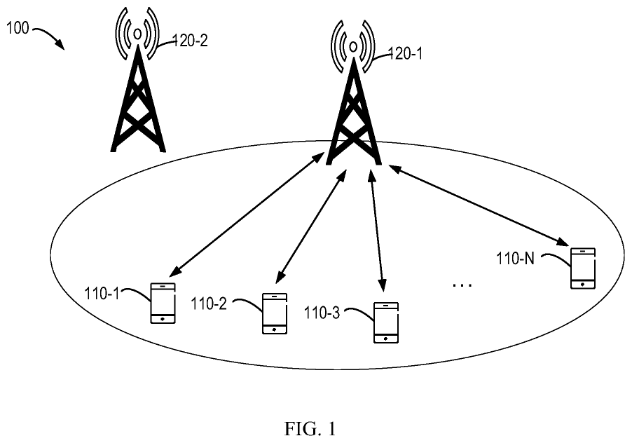

FIG. 1 illustrates a schematic diagram of a communication system in which embodiments of the present disclosure can be implemented. The communication system 100, which is a part of a communication network, comprises a first device 110-1, a first device 110-2, a first device 110-3, . . . , and a first device 110-N, which can be collectively referred to as “first device(s) 110. In some example embodiments, the first device(s) 1110 may refer to terminal devices. The communication system 100 further comprises a second device 120-1 and a second device 120-2. In some example embodiments, the second devices 120-1 and 120-2 may refer to network devices. For instance, the second devices 120-1 and 120-2 may refer to transmission and reception points (TRPs). It is to be understood that the number of devices shown in FIG. 1 is given for the purpose of illustration without suggesting any limitations. The communication system 100 may comprise any suitable number of devices and cells. In the communication system 100, the first device 110 and the second device(s) 120 can communicate data and control information to each other. In the case that the first device 110 is the terminal device and the second device 120 is the network device, a link from the second device 120 to the first device 110 is referred to as a downlink (DL), while a link from the first device 110 to the second device 120 is referred to as an uplink (UL).

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

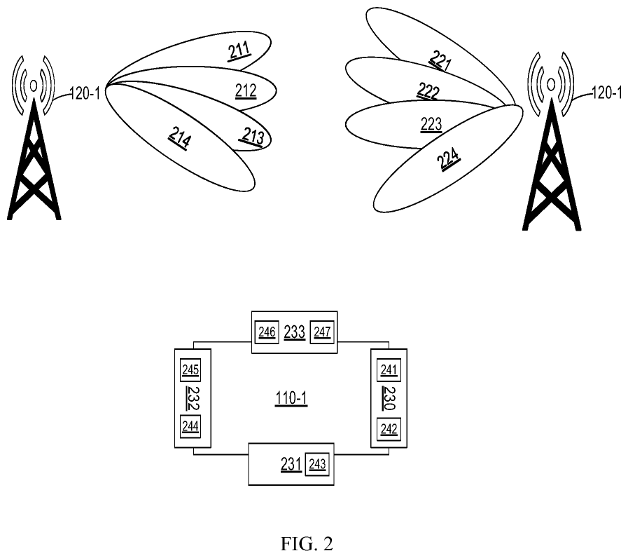

FIG. 2 illustrates a schematic diagram of antenna arrangements according to embodiments of the present disclosure. Referring to FIG. 2, the first device 110-1 may be configured with 4 antenna arrangements 230, 231, 232 and 233. There may be two transmission antenna ports 241 and 242 in the antenna arrangement 230, one transmission antenna port 243 in the antenna arrangement 231, two transmission antenna ports 244 and 245 in the antenna arrangement 232 and two transmission antenna ports 246 and 247 in the antenna arrangement 233.

In some example embodiments, the first device 110-1 may be configured with one or more synchronization signal and physical broadcast channel blocks (SSBs). For example, the first device 110-1 may be configured with one or more SSB resource indicator (SSBRI). Alternatively, the first device 110-1 may also be configured with one or more channel state information (CSI) resource sets for the second devices. For example, the first device 110-1 may be configured with CSI-RS resource indicators (CRIs) 211, 212, 213 and 214 for the second device 120-1, and configured with CRIs 221, 222, 223 and 224 for the second device 120-2. Moreover, the first device 110-1 may be configured with 6 UL SRS resource sets with usage of codebook (CB), i.e. SRS resource set #0, SRS resource set #1, SRS resource set #2, SRS resource set #3, SRS resource set #4, and SRS resource set #5. Each of the SRS resource sets may be configured with a corresponding DL CSI-RS resource as spatial relation for UL transmission. Table 1 below shows an example of associations between the SRS resource sets and the CSI-RS resource. It should be noted that Table 1 is only an example not limitation.

TABLE 1

| | |
|---|---|
| SRS resource set #0 (usage = CB) | CRI 211 |
| SRS resource #6 | |
| SRS resource set #1 (usage = CB) | CRI 212 |
| SRS resource #7 | |
| SRS resource set #2 (usage = CB) | CRI 213 |
| SRS resource #8 | |
| SRS resource set #3 (usage = CB) | CRI 214 |
| SRS resource #9 | |
| SRS resource set #4 (usage = CB) | CRI 221 |
| SRS resource #10 | |
| SRS resource set #5 (usage = CB) | CRI 222 |
| SRS resource #11 | |

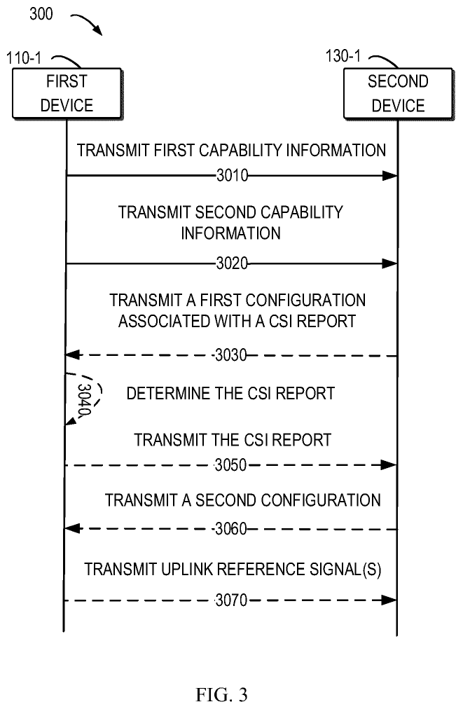

Example embodiments of the present disclosure will be described in detail below with reference to the accompanying drawings. Reference is now made to FIG. 3, which illustrates a signaling flow 300 according to example embodiments of the present disclosure. Only for the purpose of illustrations, the signaling flow 300 involves the first device 110-1 and the second device 120-1.

The first device 110-1 transmits 3010 first capability information to the second device 120-1. The first capability information indicates a list of UE capability value sets. Each UE capability value set defines an antenna arrangement of the first device 110-1. Each UE capability value set is characterized by a first number of transmission antenna ports. The first capability information may be transmitted via proper signaling, for example, RRC signaling. In some example embodiments, each UE capability value set may have an index which can be used to identity the corresponding antenna arrangement. For example, the first capability information may comprise a UE capability value set index #0 corresponding to the antenna arrangement 230, a UE capability value set index #1 corresponding to the antenna arrangement 231, a UE capability value set index #2 corresponding to the antenna arrangement 232, and a UE capability value set index #3 corresponding to the antenna arrangement 233. The term “antenna arrangement” or “antenna panel” used herein can refer to a logical grouping of transmission antenna elements or a physical grouping of transmission antenna elements. It should be noted that terms “antenna arrangement” and “antenna panel” can be used interchangeable.

In some other embodiments, the first capability information may indicate other UE capability parameter(s). For example, the first capability information may comprise the maximum number of transmission antenna ports, for instance the maximum number of SRS antenna ports, supported by an antenna arrangement of the first device 110-1.

Referring back to FIG. 3, the first device 110-1 transmits 3020 second capability information to the second device 120-1. The second capability information indicates a group of UE capability value sets. The group of UE capability value sets defines a plurality of antenna arrangements of the first device 110-1. The second capability information may be transmitted via proper signaling, for example, RRC signaling. In some example embodiments, the second capability information may comprise indexes of UE capability value sets in the group. Alternatively, the second capability information may comprise the UE capability value sets in the group. For example, if the group of UE capability value sets defines the antenna arrangements 230 and 231, the second capability information may comprise the UE capability value set index #0 and the UE capability value set index #1.

In some example embodiments, the second capability information may indicate coherence information in phase domain between transmission antenna ports of the plurality of antenna arrangements. For example, if the group of UE capability value sets defines the antenna arrangements 230 and 231, the second capability information may indicate coherence information in phase domain between the transmission antenna ports 241, 242 and 243. In some example embodiments, the coherence information may indicate full coherence in phase domain between transmission antenna ports of the plurality of antenna arrangements. Alternatively, the coherence information may indicate partial coherence in phase domain between transmission antenna ports of the plurality of antenna arrangements. In this case, in some example embodiments, the second capability information may also indicate the number (also referred to as the second number) of transmission antenna ports of the plurality of antenna arrangements with partial coherence in phase domain. For example, if the coherence information indicates the partial coherence in phase domain between the transmission antenna ports 241, 242 and 243 and two of the three transmission antenna ports are coherent, the second capability information may indicate two transmission antenna ports with partial coherence in phase domain. In some other embodiments, the coherence information may indicate non-coherence in phase domain between transmission antenna ports of the plurality of antenna arrangements.

In some example embodiments, the second capability information may indicate coherence information in phase domain between the plurality of antenna arrangements. For example, if the group of UE capability value sets defines the antenna arrangements 230 and 231, the second capability information may indicate coherence information in phase domain between the antenna arrangements 230 and 231. In some example embodiments, the coherence information may indicate full coherence in phase domain between the plurality of antenna arrangements. Alternatively, the coherence information may indicate partial coherence in phase domain between the plurality of antenna arrangements. In this case, in some example embodiments, the second capability information may also indicate a second number of the plurality of antenna arrangements with partial coherence in phase domain. In some other embodiments, the coherence information may indicate non-coherence in phase domain between the plurality of antenna arrangements.

Alternatively or in addition, the second capability information may indicate a total number of transmission antenna ports of the plurality of antenna arrangements. For example, if the group of UE capability value sets defines the antenna arrangements 230 and 231, the second capability information may the total number of transmission antenna ports is 3.

In some example embodiments, the second capability information may comprise an implicit indication of physical tracking reference signal (PTRS) transmission based on the coherence information. For example, if the coherence information indicates non-coherence in phase domain, the second capability information may indicate the number (also referred to as the third number) of PTRS antenna ports equal to the number (also referred to as the fourth number) of UE capability value sets in the group of UE capability value sets. Alternatively, if the coherence information indicates non-coherence in phase domain, the second capability information may indicate the number (also referred to as the third number) of PTRS antenna ports equal to the number (also referred to as the fourth number) of antenna arrangements in the plurality of antenna arrangements. In other words, when the coherence information indicates non-coherent or partially coherent, the number of required UL PTRS antenna ports associated with DMRS transmission may be implicitly indicated by the number of different UE capability value set index values in the group. Alternatively, if the coherence information indicates full coherence in phase domain, the second capability information may indicate the number of PTRS antenna ports equal to a predetermined number. For example, the predetermined number may be any proper number, such as one. In other words, when the coherence information indicates full coherent, the number of required UL PTRS antenna ports associated with DMRS transmission may be implicitly assumed or indicated to be the predetermined number.

Alternatively, the second capability information may comprise an explicit indication of PTRS transmission. For example, the second capability information may explicitly indicate the number of PTRS antenna ports. In other words, in the case of explicit indication, the number of required UL PTRS antenna ports associated with DMRS transmissions may be explicitly indicated in the second capability information.

In some example embodiments, the second capability information may comprise full transmission power (FP) capability information, e.g. FP capability according to some reported power class or supported FP mode(s): mode 1 and/or mode 2 and/or mode2 with transmit precoding matrix indicator (TPMI) restrictions, or any other mode with or without TPMI restrictions, when the plurality of antenna arrangements are simultaneously used for transmission. Here, TPMI refers to that only subset of TPMIs associated with codebook is supported. For example, if the group of UE capability value sets defines the antenna arrangements 230 and 231, the second capability information may indicate the full transmission power capability, e.g. Mode2 with TPMI restrictions, when the antenna arrangements 230 and 231 are simultaneously used for transmission. The full transmission power capability information may indicate whether the first device 110-1 can use full transmission power for the group according to reported capability transmission power class. For example, in some example embodiments, if the first device 110-1 is capable of supporting full transmission power with the group according to reported UE transmission power class, the second capability may indicate a full transmission power parameter set to yes or set to “1”. Alternatively, at least one of supported FP modes, e.g. Mode-1, Mode-2, Mode-2 with TPMI restriction or new Mode or new Mode with TPMI restrictions can included into information. Here, New Mode refers to FP TX capability with >4 TX APs. Alternatively, if the first device 110-1 is not capable of supporting full transmission power, the second capability may indicate a full transmission power parameter set to no or set to “0” and a transmission power relaxation. For example, the transmission power relaxation may be X dB, where X can be any suitable value.

The second device 120-1 may transmit 3030 a first configuration associated with a CSI report to the first device 110-1. In other words, the first device 110-1 may receive the first configuration from the second device 120-1. In some example embodiments, the first configuration may be transmitted via RRC signaling. In some example embodiments, the first configuration of the CSI report may indicate the number (also referred to as the sixth number and represented as “L” hereinafter) of groups of UE capability value sets in the CSI report.

In some example embodiments, the first configuration of the CSI report may also indicate the number (also referred to as the seventh number and represented as “K” hereinafter) of downlink reference signal resources associated with each group of UE capability value sets. For example, the first configuration may indicate K different DL SSB index/indices or non-zero power NZP-CSI-RS resource IDs associated with single capability value set group. K can be either configured explicitly by a network or a fixed value. For example, K may be 2 and the CRIs 211 and 221 may be associated with one group of UE capability value sets. Alternatively or in addition, the first configuration of the CSI report may indicate the number (also referred to as the eighth number and represented as “P” hereinafter) of measurement results associated with each group of UE capability value sets.

The first device 110-1 may determine 3040 the CSI report based on the first configuration. The first device 110-1 may transmit 3050 the CSI report to the second device 120-1. That is, the second device 120-1 may receive the CSI report from the first device 110-1. In some example embodiments, for each group of UE capability value sets, the CSI repot may indicate one or more indexes of one or more respective downlink reference signal resources, and one or more values of one or more respective measurement results. In some example embodiments, the measurement result may comprise reference signal received power (RSRP). Alternatively, the measurement result may comprise received signal strength indicator (RSSI). Alternatively, the measurement result may comprise signal-to-noise plus interference ration (SINR). For example, in some example embodiments, when the first device 110-1 is configured with K equal to P, there can be one-to-one mapping between the measurement result (for example, RSRP) and the downlink reference signal resources. The first device 110-1 may determine P L1-RSRP values with antenna arrangements associated with a group of capability value sets. In other embodiments, when the first device 110-1 is configured with K larger than 1 and P equal to 1, there can be many-to-one association between downlink reference signal resources and RSRP value. The first device 110-1 may determine single L1-RSRP values with antenna arrangements associated with a group of capability value sets. In other words, the first device 110-1 may determine a single L1-RSRP value such that each L1-RSRP value of DL RS resource (e.g., NZP-CSI-RS or SSB resource), up to K, associated with a respective capability set index within the group of capability value sets are aggregated/averaged (e.g., arithmetic mean is computed) over the different capability value sets indexes within the group of capability value sets.

In some example embodiments, the first configuration of the CSI report may indicate a target coherence type. In this case, the CSI report may indicate one or more groups of UE capability value sets with the target coherence type. For example, the first device 110-1 can be configured to report DL resources and capability set group IDs according to some specific TX phase-coherence type, i.e., fully/partially/non-coherent. In this case, for example, when the first device 110-1 is configured to report transmission phase-coherency being partial, the first device 110-1 may report capability set group IDs with coherency-info equal to partially coherent. Alternatively, if the first device 110-1 is not configured to report with any specific transmission phase-coherency information, the first device 110-1 may report L best groups of UE capability value sets, independent of coherency information.

In some example embodiments, the first device 110-1 may be configured to report L-best capability value set group IDs associated with DL RS resources (e.g., NZP-CSI-RS or SSB resources). The reported group IDs may be same or different and L best groups with corresponding SSB or NZP-CSI-RS resource IDs can be reported. In some example embodiments, if K is larger than 1 and P equals to 1, the first device 110-1 may select the L-best groups and corresponding DL RS resources according to corresponding L1-RSRP values.

Alternatively, the first device 110-1 may determine one or more groups of UE capability value sets which have measurement results exceeding a threshold value. In this case, the first device 110-1 may select the sixth number of groups of UE capability value sets with the best sixth number of measurement results. The threshold value may be configured by the network or may be a predetermined value. For example, if K equals to P, the first device 110-1 may select the L-best groups according to the following way: each of P L1-RSRP values associated with a group of UE capability value sets needs to be above a power threshold, where power threshold is configured separately by a network. If all P RSRP values associated with the group of UE capability value sets are above the power threshold, the group can be considered to be a valid group. For each of the valid group, the first device 110-1 may compute arithmetic mean value over associated RSRP values. Based on the computed arithmetic mean value, the first device 110-1 may order the groups in descending order out of which the first device 110-1 may select L-best (=highest) RSRP values associated with group IDs. In some example embodiments, if the first device 110-1 is not able to report L-best groups of UE capability value sets associated with DL RS resources (e.g., NZP-CSI-RS or SSB resources) with some specifically configured transmission phase-coherency type information, the CSI report may comprise N+1 times replica of the Q-th selected group ID with corresponding DL RS resources and related L1-RSRP values, where N=L-Q. For example, if both K and P are equal to 2, with DL RSs, the first device 110-1 may be configured to report two best transmission groups (L=2) with partial phase coherency type information, but there are only 1 group, i.e. c-gID #0 (capability value set group ID #0) with DL RSs (CRI #211, CRI #221 as shown in FIG. 2) and L1-RSRP values (RSRP (#211), RSRP (#221)), for qualifying the predetermined criteria (i.e. Q=1, a group to be a valid group according to above defined criteria) with DL. In this case, the value of N=2-1, the CSI report may have the following elements: CRI #211, CRI #221, RSRP (#211), RSRP (#221), CRI #211, CRI #221, RSRP (#211), RSRP (#221), c-gID #0, c-gID #0.

The second device 120-1 may transmit 3060 a second configuration of uplink reference signal resource sets to the first device 110-1. In other words, the first device 110-1 may receive the second configuration from the second device 120-1. The second configuration may indicate coherence information in phase domain between resources in the uplink reference resource set. The first device 110-1 may transmit 3070 uplink reference signals of the uplink reference signal resources sets in accordance with the coherence information in phase domain between the uplink reference resources within the uplink reference resource set to the second device 120-1. That is, the second device 120-1 may receive the uplink reference signals of the uplink reference signal resources sets from the first device 110-1. Based on the reported second capability information the second device 120-1 may configure or schedule UL SRS resources for simultaneous multi-panel UL transmission. In other words, the second device 120-1 may determine transmission of UL SRS resource set(s) with usage type of codebook and determine/limit the number of hypothesis associated with different UL TX codebook candidates for simultaneous multi-panel UL transmission for PUSCH.

In some example embodiments, the first device 110-1 may be configured with one or more UL SRS resource sets as ‘codebook’ for simultaneous multi-panel UL SRS transmission. In this case, each UL SRS resource set may be associated with a new information element, i.e., ‘transmission-coherency’ that defines the transmission phase coherency for all resources and antenna ports within the set. The first device 110-1 can be configured with multiple UL SRS resource sets with same or different TX-coherency information.

The second device 110-1 may assume that ‘TX-coherency’ information is obtained via UL CSI reporting procedure with the second capability information. For example: if both K and P are equal to 2 and L is equal to 2, the first device 110-1 may report two best group of UE capability value sets with full coherency type information as follows: c-gID #0 {CRI #211, CRI #221, RSRP (#211), RSRP (#221)}, c-gID #1 {CRI #213, CRI #224, RSRP (#213), RSRP (#224)}, c-gID #0, c-gID #1. Furthermore, in some example embodiments, the first device 110-1 may be preconfigured with four different UL SRS resource sets as: UL SRS resource set #0 with SRI #6 where CRI #211 is configured as spatial relation for SRI #6, UL SRS resource set #4 with SRI #10 where CRI #221 is configured as spatial relation for SRI #10, UL SRS resource set #2 with SRI #8 where CRI #213 is configured as spatial relation for SRI #8, and UL SRS resource set #5 with SRI #11 where CRI #222 is configured as spatial relation for SRI #11.

Based on the reported UL CSI and pre-configured SRS resource sets, the first device 110-1 may be configured with two SRS resource sets with different TX-coherence information as: UL SRS resource set #10 with usage=‘codebook’ and TX-coherency=‘fully AndPartialAndNonCoherent’ with 2-AP SRI #10 with CRI #23 as spatial relation and 2-AP SRI #11 with CRI #43 as spatial relation: UL SRS resource set #11 with usage=‘codebook’ and TX-coherency=‘PartialAndNonCoherent’ with 2-AP SRI #12 with CRI #11 as spatial relation and 2-AP SRI #13 with CRI #33 as spatial relation.

In some example embodiments, the second device 120-1 may determine a set of ranks and a set of precoders for uplink reference signals within an uplink reference signal resource set based on the coherence information. For example, when the first device 110-1 is configured/triggered to transmit above UL SRS resource set configuration, the second device 120-1 may determine the number of different hypotheses to be performed for UL precoder selection, i.e., transmitting precoder matrix indicator (TPMI) and rank, across resources within the UL SRS resource set with ‘TX-coherency’ information, for simultaneous multi-panel codebook based PUSCH transmission.

In some other embodiments, the second device 120-1 may determine the number (also referred to as the ninth number) of PTRS antenna ports based on the set of ranks and the set of precoders. In other words, the second device 120-1 may determine transmission of PTRS in terms of number of ports and used patterns in time and frequency. For example, the second capability information may comprise information related the required number of PTRS antenna ports associated with antenna panels for simultaneous multi-panel transmission. Based on this information, the network device 120-1 may configure UL PTRS resources (in time and frequency) for the first device 110-1 accordingly in conjunction with UL DMRS resources (in time and frequency).

Alternatively, or in addition, the second device 120-1 may determine the number (also referred to as the tenth number) of demodulation reference signal (DMRS) antenna ports based on the set of ranks and the set of precoders. In other words, the second device 120-1 may determine transmission of DM-RS in terms of number of ports and used patterns in time and frequency. The number of DMRS antenna ports to be configured may depend on the selection of UL precoder (TPMI) and rank that is performed based on UL SRS resource set transmissions.

According to embodiments described with reference to FIG. 3, it enables simultaneous multi-antenna panel codebook-based UL transmission with different antenna panels having different capabilities (e.g., number of antenna ports, TX coherency, TX power or full power modes). Moreover, it also enables to configure the terminal device with UL SRS resources according to TX phase coherency information between different TX antenna panel or antenna arrangement combinations. In addition, by using the reported second capability information, the UE transmission antenna panel information can be either captured in a non-transparent or transparent manner. By using the reported second capability information, it enables network to configure dynamically UL SRS, DMRS and PTRS resources according to UE TX antenna panel capabilities.

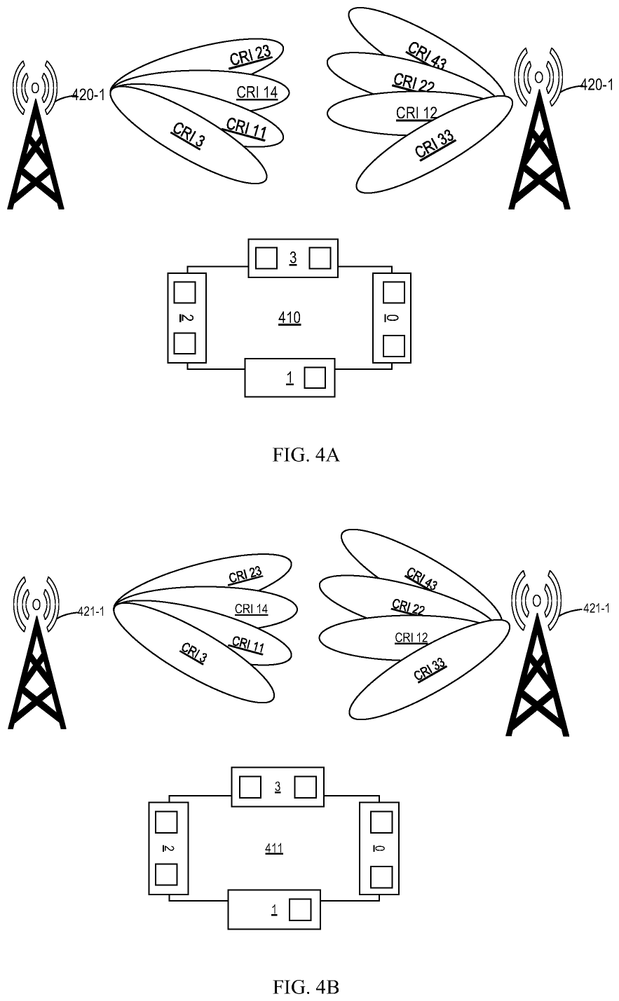

FIGS. 4A and 4B illustrate schematic diagrams of antenna arrangements and resource allocations according to embodiments of the present disclosure. The TPRs 420-1 and 420-2 shown in FIG. 4A may be implemented at the second devices 120-1 and 120-2 as shown in FIG. 1. The terminal device 410 shown in FIG. 4A may be implemented at the first device 110-1 as shown in FIG. 1. The TPRs 421-1 and 421-2 shown in FIG. 4B may be implemented at the second devices 120-1 and 120-2 as shown in FIG. 1. The terminal device 411 shown in FIG. 4B may be implemented at the first device 110-1 as shown in FIG. 1.

FIG. 4A provides an example of proposed capability value set group reporting associated with DL RS resources (e.g., NZP-CSI-RS or SSB resources) of the two TRPs 420-1 and 420-2. The terminal device 410 may be equipped with four TX antenna arrangements (0, 1, 2 and 3) with different number of antenna ports in each antenna arrangement. The terminal device 410 may be configured with NZP-CSI-RS resource sets #1 with corresponding resources (for example, CRI #23, CRI #14, CRI #11, CRI #3) and NZP-CSI-RS resource sets #2 with corresponding resources (for example, CRI #43, CRI #22, CRI #12, CRI #33). Moreover, the terminal device 410 may be pre-configured with six UL SRS resource sets with usage of codebook, i.e., SRS-set #3, SRS-set #5 SRS-set #7, SRS-set #9, SRS-set #11, SRS-set #13. Each of the SRS resource set may be configured with a DL RS, e.g. a DL CSI-RS resource, as spatial relation for potential UL transmission. Table 2 below shows an example of associations between the SRS resource sets and the CSI-RS resources. It should be noted that Table 1 is only an example not limitation.

TABLE 2

| | |
|---|---|
| SRS-set#3 (usage = “codebook”) | CRI#23 as spatialRelation |
| SRS resource #12 | |
| SRS-set#5 (usage = “codebook”) | CRI#43 as spatialRelation |
| SRS resource #42 | |
| SRS-set#7 (usage = “codebook”) | CRI#11 as spatialRelation |
| SRS resource #4 | |
| SRS-set#9 (usage = “codebook”) | CRI#14 as spatialRelation |
| SRS resource #20 | |
| SRS-set#11 (usage = “codebook”) | CRI#3 as spatialRelation |
| SRS resource #17 | |
| SRS-set#13 (usage = “codebook”) | CRI#33 as spatialRelation |
| SRS resource #31 | |

The terminal device 410 may report the second capability information to the TRPs 420-1 and 420-2. The second capability information may comprise UE capability value set groups, i.e., UE capability group ID indices #0, #1 and #2. Each of the group may comprise TX phase coherence information (C-info), number of partially coherent TX antenna ports (Par-Tx-Ant), total number of TX antenna ports (tx Total) which can be also optional because the total number TX SRS antenna ports can be obtained from the number of antenna ports associated with different capability value set indices, capability value set indexes/indices (c-index), phase tracking reference signal antenna port info (PTRS). Due to the UE vendor specific implementation constraints between different UE TX antenna panel combinations, the terminal device 410 may have three different capability set index groups, i.e., C-gid #0, #1, and #2. The terminal device 410 may be configured for reporting three different UL TX capability groups with corresponding DL RS resources without any constraint on TX phase coherency.

Table 3 shows an example of the UE capability value set group #0, Table 4 shows an example of the UE capability value set group #1, and Table 5 shows an example of the UE capability value set group #2.

TABLE 3

C-info = full-coherence
Par-txAnt = —
txTotal = 4
c-index = #2, #3
PTRS = 1

TABLE 4

C-info = part-coherence
Par-txAnt = 2
txTotal = 4
c-index = #0, #3
PTRS = 1

TABLE 5

C-info = non-coherence
Par-txAnt = —
txTotal = 3
c-index = #0, #1
PTRS = 2

The terminal device 410 may be also configured to perform reporting with K=2, P=2 and L=3. In other words, the terminal device 410 may report three (L=3) TX capability value set groups, where each capability value set group is associated with two (K=2) DL RS resource indices and two (P=2) L1-RSRP values. The terminal device 410 may be configured with a specific power threshold associated with TX capability value set groups. Each of L1-RSRP values associated with a group needs to be above a power threshold (e.g., RSRP values to be larger than x dBm). If all RSRP values associated with a group are above the threshold, the group can be considered to be valid group. For each of the valid group, the terminal device 410 may compute arithmetic mean value over associated RSRP values. Based the computed arithmetic mean value, the terminal device 410 may order the groups in descending order out of which the terminal device 410 may select L-best (=highest) RSRP values associated with group IDs to be included into a reporting instance. The reporting can be done via MAC CE (via PUSCH) and/or physical level signaling (via PUCCH). For example, the CSI report where K=2, P=2 and L=3 may comprise the followings: CRI #23 (TRP 420-1), CRI #43 (TPR 420-2), RSRP (CRI #23), RSRP (CRI #43), CRI #14 (TRP 420-1), CRI #12 (TRP 420-2), RSRP (CRI #14), RSRP (CRI #12), CRI #3 (TRP 420-1), CRI #12 (TRP 420-2), RSRP (CRI #3), RSRP (CRI #12), C-gID #0, C-gID #1, C-gID #2.

Based on reported second capability information and DL resources, the network can configure/schedule: transmission of UL SRS resource set(s) with usage type of codebook: transmission of PT-RS in terms of number of ports and used patterns in time and frequency; transmission of DM-RS in terms of number of ports and used patterns in time and frequency. The network may determine/limit the number of hypothesis associated with different UL TX codebook candidates for simultaneous multi-antenna panel UL transmission associated with PUSCH/PUCCH.

FIG. 4B provides an example of reporting of capability set index group information with DL RS resources (e.g., NZP-CSI-RS or SSB resources) with partial-coherency reporting restriction with two TRPs 421-1 and 421-2. The terminal device 411 may be equipped with four TX antenna arrangements (0, 1, 2 and 3) with different number of antenna ports in each antenna panel. The terminal device 411 may be configured with NZP-CSI-RS resource sets #1 with corresponding resources (for example, CRI #23, CRI #14, CRI #11, CRI #5) and NZP- CSI-RS resource sets #2 with corresponding resources (for example, CRI #43, CRI #22, CRI #12, CRI #33). Moreover, the terminal device 411 may be pre-configured with six UL SRS resource sets with usage of codebook, i.e., SRS-set #3, SRS-set #5 SRS-set #7, SRS resource-set #9, SRS resource-set #11, SRS resource-set #13. Each of the SRS resource set may be configured with a DL RS (e.g., CSI-RS or SSB) as spatial relation for potential UL transmission. Table 6 below shows an example of associations between the SRS resource sets and the CSI-RS resource. It should be noted that Table 1 is only an example not limitation.

TABLE 6

| | |
|---|---|
| SRS-set#3 (usage = “codebook”) | CRI#23 as spatialRelation |
| SRS resource #12 | |
| SRS-set#5 (usage = “codebook”) | CRI#43 as spatialRelation |
| SRS resource #42 | |
| SRS-set#7 (usage = “codebook”) | CRI#11 as spatialRelation |
| SRS resource #4 | |
| SRS-set#9 (usage = “codebook”) | CRI#14 as spatialRelation |
| SRS resource #20 | |
| SRS-set#11 (usage = “codebook”) | CRI#3 as spatialRelation |
| SRS resource #17 | |
| SRS-set#13 (usage = “codebook”) | CRI#33 as spatialRelation |
| SRS resource #31 | |

The terminal device 411 may report the second capability information to the TRPs 420-1 and 420-2. In addition, each capability value set group may also comprise full TX-power capability (full-TX-pow) associated with each group. If the terminal device 411 is capable of supporting full-TX power with the group according to reported UE TX power class, full-TX-power parameter is set to yes. Otherwise, full-TX-power parameter is set to no and TX power relaxation is associated with it, e.g., 4 dB like with C-giD #1.

Table 7 shows an example of the UE capability value se group #0, Table 8 shows an example of the UE capability value se group #1, and Table 9 shows an example of the UE capability value se group #2.

TABLE 7

C-info = full-coherence
Par-txAnt = —
txTotal = 4
c-index = #2, #3
PTRS = 1
Full-TX-pow = yes

TABLE 8

C-info = part-coherence
Par-txAnt = 2
txTotal = 4
c-index = #0, #3
PTRS = 1
Full-TX-pow = no, relaxation = 4 dB

TABLE 9

C-info = non-coherence
Par-txAnt = —
txTotal = 3
c-index = #0, #1
PTRS = 2
Full-TX-pow = no, relaxation = 4 dB

If the terminal device 411 is configured with partial-coherency reporting restriction and L=2, the terminal device 411 may report with DL NZP-CSI-RS resource IDs with two best groups (reported group IDs can be same or different, only best groups with corresponding NZP-CSI-RS resource IDs are reported.) For example, the CSI report where K=2, P=2 and L=2 may comprise the followings: CRI #14 (TRP 420-1), CRI #12 (TPR 420-2), RSRP (CRI #14), RSRP (CRI #12), CRI #11 (TRP 420-1), CRI #33 (TRP 420-2), RSRP (CRI #11), RSRP (CRI #33), C-gID #1, C-gID #2. In other embodiments, the L best UE capability value set groups can be reported separately. In this case, the information about C-gID #1 or C-gID #2 may not be in the CSI report, but in another CSI report to be sent separately.

Based on reported second capability information and DL resources, the network can have awareness whether the terminal device 411 can transmit with full TX power or not with potential power relaxation with UL SRS resources associated with reported DL NZP-CSI-RS resources and group IDs. This information can be beneficial for network to configure the UL SRS, DMRS and PTRS properly. Furthermore, the network can have better understanding whether UL resource configurations are sufficient for intended service coverage.

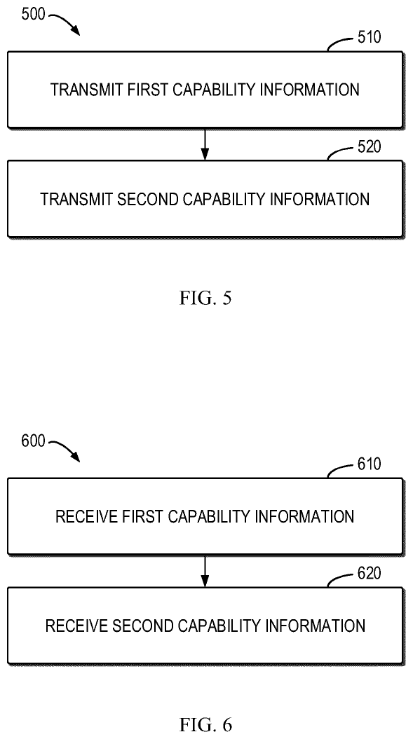

FIG. 5 illustrates a flow chart of method 500 according to embodiments of the present disclosure. The method 500 can be implemented at any suitable devices. For example, the method may be implemented at the first device 110-1.

At block 510, the first device 110-1 transmits first capability information to the second device 120-1. The first capability information indicates a list of UE capability value sets. Each UE capability value set defines, identifies, or is associated with an antenna arrangement of the first device 110-1. Each UE capability value set is characterized by a first number of transmission antenna ports. The first capability information may be transmitted via proper signaling, for example, RRC signaling. In some example embodiments, each UE capability value set may have an index which can be used to identity the corresponding antenna arrangement.

In some other embodiments, the first capability information may comprise other UE capability parameter(s). For example, the first capability information may comprise the maximum number of transmission antenna ports, for instance the maximum number of SRS antenna ports, supported by an antenna arrangement of the first device 110-1.

At block 520, the first device 110-1 transmits second capability information to the second device 120-1. The second capability information indicates a group of UE capability value sets. The group of UE capability value sets defines a plurality of antenna arrangements of the first device 110-1. The second capability information may be transmitted via proper signaling, for example, RRC signaling. In some example embodiments, the second capability information may comprise indexes of UE capability value sets in the group. Alternatively, the second capability information may comprise the UE capability value sets in the group.

In some example embodiments, the second capability information may indicate coherence information in phase domain between transmission antenna ports of the plurality of antenna arrangements. In some example embodiments, the coherence information may indicate full coherence in phase domain between transmission antenna ports of the plurality of antenna arrangements. Alternatively, the coherence information may indicate partial coherence in phase domain between transmission antenna ports of the plurality of antenna arrangements. In this case, in some example embodiments, the second capability information may also indicate the number (also referred to as the second number) of transmission antenna ports of the plurality of antenna arrangements with partial coherence in phase domain. In some other embodiments, the coherence information may indicate non-coherence in phase domain between transmission antenna ports of the plurality of antenna arrangements.

In some example embodiments, the second capability information may indicate coherence information in phase domain between the plurality of antenna arrangements. In some example embodiments, the coherence information may indicate full coherence in phase domain between the plurality of antenna arrangements. Alternatively, the coherence information may indicate partial coherence in phase domain between the plurality of antenna arrangements. In this case, in some example embodiments, the second capability information may also indicate a second number of the plurality of antenna arrangements with partial coherence in phase domain. In some other embodiments, the coherence information may indicate non-coherence in phase domain between the plurality of antenna arrangements. Alternatively or in addition, the second capability information may indicate a total number of transmission antenna ports of the plurality of antenna arrangements.

FIG. 6 illustrates a flow chart of method 600 of the present disclosure. The method 600 can be implemented at any suitable devices. For example, the method may be implemented at the second device 120-1.

At block 610, the second device 120-1 receives first capability information from the first device 110-1. The first capability information comprises a list of UE capability value sets. Each UE capability value set defines, identifies, or is associated with an antenna arrangement of the first device 110-1. Each UE capability value set is characterized by a first number of transmission antenna ports. The first capability information may be transmitted via proper signaling, for example, RRC signaling. In some example embodiments, each UE capability value set may have an index which can be used to identity the corresponding antenna arrangement.

In some other embodiments, the first capability information may comprise other UE capability parameter(s). For example, the first capability information may comprise the maximum number of transmission antenna ports, such as the maximum number of SRS antenna ports, supported by an antenna panel of the first device 110-1.

At block 620, the second device 120-1 receives second capability information from the first device 110-1. The second capability information indicates a group of UE capability value sets. The group of UE capability value sets defines a plurality of antenna arrangements of the first device 110-1. The second capability information may be transmitted via proper signaling, for example, RRC signaling. In some example embodiments, the second capability information may comprise indexes of UE capability value sets in the group. Alternatively, the second capability information may comprise the UE capability value sets in the group.

In some example embodiments, the second capability information may indicate coherence information in phase domain between transmission antenna ports of the plurality of antenna arrangements. In some example embodiments, the coherence information may indicate full coherence in phase domain between transmission antenna ports of the plurality of antenna arrangements. Alternatively, the coherence information may indicate partial coherence in phase domain between transmission antenna ports of the plurality of antenna arrangements. In this case, in some example embodiments, the second capability information may also indicate the number (also referred to as the second number) of transmission antenna ports of the plurality of antenna arrangements with partial coherence in phase domain. In some other embodiments, the coherence information may indicate non-coherence in phase domain between transmission antenna ports of the plurality of antenna arrangements.

In some example embodiments, the second capability information may indicate coherence information in phase domain between the plurality of antenna arrangements. In some example embodiments, the coherence information may indicate full coherence in phase domain between the plurality of antenna arrangements. Alternatively, the coherence information may indicate partial coherence in phase domain between the plurality of antenna arrangements. In this case, in some example embodiments, the second capability information may also indicate a second number of the plurality of antenna arrangements with partial coherence in phase domain. In some other embodiments, the coherence information may indicate non-coherence in phase domain between the plurality of antenna arrangements. Alternatively or in addition, the second capability information may indicate a total number of transmission antenna ports of the plurality of antenna arrangements.

In some example embodiments, a first apparatus for performing the method 500 (for example, the first device 110-1) may comprise respective means for performing the corresponding steps in the method 500. These means may be implemented in any suitable manners. For example, it can be implemented by circuitry or software modules.

In some example embodiments, a first device comprises means for transmitting, to a second device, first capability information indicating a list of user equipment, UE, capability value sets, wherein each UE capability value set in the list defines an antenna arrangement of the first device and is characterized by a first number of transmission antenna ports; and means for transmitting, to the second device, second capability information indicating: a group of UE capability value sets, wherein the group of UE capability value sets defines a plurality of antenna arrangements of the first device, and coherence information in phase domain between transmission antenna ports of the plurality of antenna arrangements or between the plurality of antenna arrangements.

In some example embodiments, the coherence information indicates one of: full coherence in phase domain between transmission antenna ports of the plurality of antenna arrangements or between the plurality of antenna arrangements, partial coherence in phase domain between transmission antenna ports of the plurality of antenna arrangements or between the plurality of antenna arrangements, or non-coherence in phase domain between transmission antenna ports of the plurality of antenna arrangements or between the plurality of antenna arrangements.

In some example embodiments, if the coherence information indicates partial coherence in phase domain, then the second capability information further indicates a second number of transmission antenna ports of the plurality of antenna arrangements or a second number of antenna arrangements with partial coherence in phase domain.

In some example embodiments, if the coherence information indicates non-coherence in phase domain, then the second capability information further indicates a third number of physical tracking reference signal, PTRS, antenna ports equal to a fourth number of UE capability value sets in the group of UE capability value sets.

In some example embodiments, if the coherence information indicates full coherence in phase domain, then the second capability information further indicates a third number of physical tracking reference signal, PTRS, antenna ports equal to a predetermined number, and preferably equal to one.

In some example embodiments, the second capability information further indicates a total number of transmission antenna ports of the plurality of antenna arrangements.

In some example embodiments, the second capability information further comprises full transmission power capability information when the plurality of antenna arrangements is simultaneously used for transmission.

In some example embodiments, the antenna arrangement is a logical grouping of transmission antenna elements of the first device, or the antenna arrangement is a physical grouping of transmission antenna elements of the first device.

In some example embodiments, the first device comprises means for receiving, from the second device, a first configuration associated with a channel state information, CSI, report, wherein the first configuration of the CSI report indicates: a sixth number of groups of UE capability value sets in the CSI report, and at least one of: a seventh number of downlink reference signal resources associated with each group of UE capability value sets, an eighth number of measurement results associated with each group of UE capability value sets. a sixth number of groups of UE capability value sets in the CSI report, and at least one of: a seventh number of downlink reference signal resources associated with each group of UE capability value sets, an eighth number of measurement results associated with each group of UE capability value sets.

In some example embodiments, the first device comprises means for determining the CSI report based on the first configuration; and means for transmitting, to the second device, the CSI report, wherein the CSI report indicates, for each group of UE capability value sets: one or more indexes of one or more respective downlink reference signal resources, one or more values of one or more respective measurement results.

In some example embodiments, the first configuration of the CSI report indicates a target coherence type, and the CSI report indicates one or more groups of UE capability value sets with the target coherence type.

In some example embodiments, the first device comprises means for determining one or more groups of UE capability value sets which have measurement results exceeding a threshold value; and means for selecting, from the one or more groups of UE capability value sets, the sixth number of groups of UE capability value sets with the best sixth number measurement values.

In some example embodiments, the first device comprises means for receiving, from the second device, a second configuration of uplink reference signal resource sets, wherein the second configuration indicates coherence information in phase domain between the uplink reference resource sets; and means for transmitting, to the second device, uplink reference signals of the uplink reference signal resources sets in accordance with the coherence information in phase domain between the uplink reference resource sets.

In some example embodiments, a second apparatus for performing the method 600 (for example, the second device 120-1) may comprise respective means for performing the corresponding steps in the method 600. These means may be implemented in any suitable manners. For example, it can be implemented by circuitry or software modules.

In some example embodiments, a second device comprises means for receiving, from a first device, first capability information indicating a list of user equipment, UE, capability value sets, wherein each UE capability value set in the list defines an antenna arrangement of the first device and is characterized by a first number of transmission antenna ports; and means for receiving, from the first device, second capability information indicating: a group of UE capability value sets, wherein the group of UE capability value sets defines a plurality of antenna arrangements of the first device, and coherence information in phase domain between transmission antenna ports of the plurality of antenna arrangements or between the plurality of antenna arrangements.

In some example embodiments, the coherence information indicates one of: full coherence in phase domain between transmission antenna ports of the plurality of antenna arrangements or between the plurality of antenna arrangements, partial coherence in phase domain between transmission antenna ports of the plurality of antenna arrangements or between the plurality of antenna arrangements, or non-coherence in phase domain between transmission antenna ports of the plurality of antenna arrangements or between the plurality of antenna arrangements.

In some example embodiments, if the coherence information indicates partial coherence in phase domain, then the second capability information further indicates a second number of transmission antenna ports of the plurality of antenna arrangements or a second number of antenna arrangements with partial coherence in phase domain.

In some example embodiments, if the coherence information indicates non-coherence in phase domain, then the second capability information further indicates a third number of physical tracking reference signal, PTRS, antenna ports equal to a fourth number of UE capability value sets in the group of UE capability value sets.

In some example embodiments, if the coherence information indicates full coherence in phase domain, then the second capability information further indicates a third number of physical tracking reference signal, PTRS, antenna ports equal to a predetermined number, and preferably equal to one.

In some example embodiments, the second capability information further indicates a total number of transmission antenna ports of the plurality of antenna arrangements.

In some example embodiments, the second capability information further comprises full transmission power capability information when the plurality of antenna arrangements is simultaneously used for transmission.

In some example embodiments, the antenna arrangement is a logical grouping of transmission antenna elements of the first device, or the antenna arrangement is a physical grouping of transmission antenna elements of the first device.

In some example embodiments, the second device comprises means for transmitting, to the first device, a first configuration associated with a channel state information, CSI, report, wherein the first configuration of the CSI report indicates: a sixth number of groups of UE capability value sets in the CSI report, and at least one of: a seventh number of downlink reference signal resources associated with each group of UE capability value sets, an eighth number of measurement results associated with each group of UE capability value sets.

In some example embodiments, the second device comprises means for receiving, from the first device, the CSI report, wherein the CSI report indicates, for each group of UE capability value sets: one or more indexes of one or more respective downlink reference signal resources, one or more values of one or more respective measurement results.

In some example embodiments, the first configuration of the CSI report indicates a target coherence type, and the CSI report indicates one or more groups of UE capability value sets with the target coherence type.

In some example embodiments, the second device comprises means for transmitting, to the first device, a second configuration of uplink reference signal resource sets, wherein the second configuration indicates coherence information in phase domain between the uplink reference resource sets; and means for receiving, from the first device, uplink reference signals of the uplink reference signal resources set.

In some example embodiments, the second device comprises means for determining a set of ranks and a set of precoders for uplink reference signals within an uplink reference signal resource set based on the coherence information.

In some example embodiments, the second device comprises means for determining, based on the set of ranks and the set of precoders, at least one of: a ninth number of physical tracking reference signal, PTRS, antenna ports, and a tenth number of demodulation reference signal, DMRS, antenna ports.

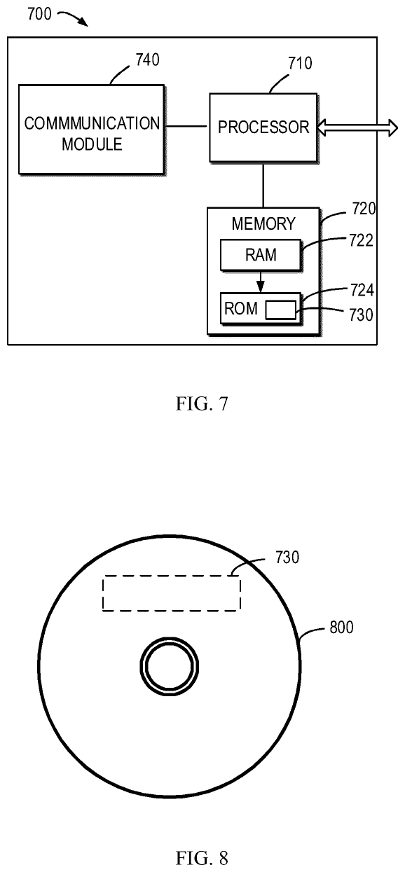

FIG. 7 is a simplified block diagram of a device 700 that is suitable for implementing embodiments of the present disclosure. The device 700 may be provided to implement the communication device, for example the first device 110, or the second device as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 720 so that the device 700 may perform any process of the disclosure as discussed with reference to FIGS. 2 and 6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods as described above with reference to FIGS. 2-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-55. (canceled)

56. A first device comprising:
at least one processor; and
at least one memory including computer program code;
the at least one memory and the computer program code are configured to, with the at least one processor, cause the first device to:
transmit, to a second device, first capability information indicating a list of user equipment (UE) capability value sets, wherein each UE capability value set in the list defines an antenna arrangement of the first device and is characterized by a first number of transmission antenna ports; and
transmit, to the second device, second capability information comprising full transmission power capability information when a plurality of antenna arrangements are simultaneously used for transmission, the second capability information indicating:
a group of UE capability value sets, wherein the group of UE capability value sets defines a plurality of antenna arrangements of the first device:
coherence information in phase domain between transmission antenna ports of the plurality of antenna arrangements or between the plurality of antenna arrangements; and
a total number of transmission antenna ports of the plurality of antenna arrangements:
receive, from the second device, a first configuration associated with a channel state information (CSI) report, wherein the first configuration of the CSI report indicates:
a sixth number of groups of UE capability value sets in the CSI report, and the following:
a seventh number of downlink reference signal resources associated with each group of UE capability value sets, and
an eighth number of measurement results associated with each group of UE capability value sets:
determine the CSI report based on the first configuration;
transmit, to the second device, the CSI report, wherein the CSI report indicates, for each group of UE capability value sets:
one or more indexes of one or more respective downlink reference signal resources, and
one or more values of one or more respective measurement results:
determine one or more groups of UE capability value sets which have measurement results exceeding a threshold value;
select, from the one or more groups of UE capability value sets, the sixth number of groups of UE capability value sets with the best sixth number measurement values;
receive, from the second device, a second configuration of uplink reference signal resource sets, wherein the second configuration indicates coherence information in phase domain between the uplink reference signal resource sets; and
transmit, to the second device, uplink reference signals of the uplink reference signal resources sets in accordance with the coherence information in phase domain between the uplink reference resource sets.

57. The first device of claim 56, wherein the coherence information indicates one of:
full coherence in phase domain between transmission antenna ports of the plurality of antenna arrangements or between the plurality of antenna arrangements,
partial coherence in phase domain between transmission antenna ports of the plurality of antenna arrangements or between the plurality of antenna arrangements, or
non-coherence in phase domain between transmission antenna ports of the plurality of antenna arrangements or between the plurality of antenna arrangements.

58. The first device of claim 57, wherein if the coherence information indicates partial coherence in phase domain, then the second capability information further indicates a second number of transmission antenna ports of the plurality of antenna arrangements or a second number of antenna arrangements with partial coherence in phase domain.

59. The first device of claim 57, wherein, if the coherence information indicates non-coherence in phase domain, then the second capability information further indicates a third number of physical tracking reference signal (PTRS) antenna ports equal to a fourth number of UE capability value sets in the group of UE capability value sets.

60. The first device of claim 57, wherein, if the coherence information indicates full coherence in phase domain, then the second capability information further indicates a third number of physical tracking reference signal (PTRS) antenna ports equal to a predetermined number, and preferably equal to one.

61. The first device of claim 60, wherein the antenna arrangement is a logical grouping of transmission antenna elements of the first device, or
the antenna arrangement is a physical grouping of transmission antenna elements of the first device.

62. The first device of claim 61, wherein the first configuration of the CSI report indicates a target coherence type, and
wherein the CSI report indicates one or more groups of UE capability value sets with the target coherence type.

63. A system comprising:
a first device;
at least one processor; and
at least one memory including computer program code;
the at least one memory and the computer program code are configured to, with the at least one processor, cause the first device to:
transmit, to a second device, first capability information indicating a list of user equipment (UE) capability value sets, wherein each UE capability value set in the list defines an antenna arrangement of the first device and is characterized by a first number of transmission antenna ports; and
transmit, to the second device, second capability information comprising full transmission power capability information when a plurality of antenna arrangements are simultaneously used for transmission, the second capability information indicating:
a group of UE capability value sets, wherein the group of UE capability value sets defines a plurality of antenna arrangements of the first device:
coherence information in phase domain between transmission antenna ports of the plurality of antenna arrangements or between the plurality of antenna arrangements; and
a total number of transmission antenna ports of the plurality of antenna arrangements:
receive, from the second device, a first configuration associated with a channel state information (CSI) report, wherein the first configuration of the CSI report indicates:
a sixth number of groups of UE capability value sets in the CSI report, and the following:
a seventh number of downlink reference signal resources associated with each group of UE capability value sets, and
an eighth number of measurement results associated with each group of UE capability value sets:
determine the CSI report based on the first configuration;
transmit, to the second device, the CSI report, wherein the CSI report indicates, for each group of UE capability value sets:
one or more indexes of one or more respective downlink reference signal resources, and
one or more values of one or more respective measurement results:
determine one or more groups of UE capability value sets which have measurement results exceeding a threshold value;
select, from the one or more groups of UE capability value sets, the sixth number of groups of UE capability value sets with the best sixth number measurement values;
receive, from the second device, a second configuration of uplink reference signal resource sets, wherein the second configuration indicates coherence information in phase domain between the uplink reference signal resource sets; and
transmit, to the second device, uplink reference signals of the uplink reference signal resources sets in accordance with the coherence information in phase domain between the uplink reference resource sets.

64. The system of claim 63, wherein the coherence information indicates one of:
full coherence in phase domain between transmission antenna ports of the plurality of antenna arrangements or between the plurality of antenna arrangements,
partial coherence in phase domain between transmission antenna ports of the plurality of antenna arrangements or between the plurality of antenna arrangements, or
non-coherence in phase domain between transmission antenna ports of the plurality of antenna arrangements or between the plurality of antenna arrangements.

65. The system of claim 64, wherein if the coherence information indicates partial coherence in phase domain, then the second capability information further indicates a second number of transmission antenna ports of the plurality of antenna arrangements or a second number of antenna arrangements with partial coherence in phase domain.

66. The system of claim 64, wherein, if the coherence information indicates full coherence in phase domain, then the second capability information further indicates a third number of physical tracking reference signal (PTRS) antenna ports equal to a predetermined number, and preferably equal to one.

67. The system of claim 64, wherein, if the coherence information indicates non-coherence in phase domain, then the second capability information further indicates a third number of physical tracking reference signal (PTRS) antenna ports equal to a fourth number of UE capability value sets in the group of UE capability value sets.

68. The system of claim 67, wherein the antenna arrangement is a logical grouping of transmission antenna elements of the first device, or
the antenna arrangement is a physical grouping of transmission antenna elements of the first device.

69. The system of claim 68, wherein the first configuration of the CSI report indicates a target coherence type, and
wherein the CSI report indicates one or more groups of UE capability value sets with the target coherence type.

70. A method comprising:
transmitting, from a first device to a second device, first capability information indicating a list of user equipment (UE) capability value sets, wherein each UE capability value set in the list defines an antenna arrangement of the first device and is characterized by a first number of transmission antenna ports; and
transmitting, to the second device, second capability information comprising full transmission power capability information when a plurality of antenna arrangements are simultaneously used for transmission, the second capability information indicating:
a group of UE capability value sets, wherein the group of UE capability value sets defines a plurality of antenna arrangements of the first device;
coherence information in phase domain between transmission antenna ports of the plurality of antenna arrangements or between the plurality of antenna arrangements; and
a total number of transmission antenna ports of the plurality of antenna arrangements:
receiving, from the second device, a first configuration associated with a channel state information (CSI) report, wherein the first configuration of the CSI report indicates:
a sixth number of groups of UE capability value sets in the CSI report, and the following:
a seventh number of downlink reference signal resources associated with each group of UE capability value sets, and
an eighth number of measurement results associated with each group of UE capability value sets:
determining the CSI report based on the first configuration;
transmitting, to the second device, the CSI report, wherein the CSI report indicates, for each group of UE capability value sets:
one or more indexes of one or more respective downlink reference signal resources, and
one or more values of one or more respective measurement results;
determining one or more groups of UE capability value sets which have measurement results exceeding a threshold value;
selecting, from the one or more groups of UE capability value sets, the sixth number of groups of UE capability value sets with the best sixth number measurement values;
receiving, from the second device, a second configuration of uplink reference signal resource sets, wherein the second configuration indicates coherence information in phase domain between the uplink reference signal resource sets; and
transmitting, to the second device, uplink reference signals of the uplink reference signal resources sets in accordance with the coherence information in phase domain between the uplink reference resource sets.

71. The method of claim 70, wherein the coherence information indicates full coherence in phase domain between transmission antenna ports of the plurality of antenna arrangements or between the plurality of antenna arrangements.

72. The method of claim 70, wherein the coherence information indicates one of:
partial coherence in phase domain between transmission antenna ports of the plurality of antenna arrangements or between the plurality of antenna arrangements, or
non-coherence in phase domain between transmission antenna ports of the plurality of antenna arrangements or between the plurality of antenna arrangements.

73. The method of claim 72, wherein if the coherence information indicates partial coherence in phase domain, then the second capability information further indicates a second number of transmission antenna ports of the plurality of antenna arrangements or a second number of antenna arrangements with partial coherence in phase domain.

74. The method of claim 72, wherein, if the coherence information indicates full coherence in phase domain, then the second capability information further indicates a third number of physical tracking reference signal, PTRS, antenna ports equal to a predetermined number, and preferably equal to one: or
wherein, if the coherence information indicates non-coherence in phase domain, then the second capability information further indicates a third number of physical tracking reference signal (PTRS) antenna ports equal to a fourth number of UE capability value sets in the group of UE capability value sets.

75. The method of claim 74, wherein the antenna arrangement is a logical grouping of transmission antenna elements of the first device, or the antenna arrangement is a physical grouping of transmission antenna elements of the first device, and
wherein the first configuration of the CSI report indicates a target coherence type, and
wherein the CSI report indicates one or more groups of UE capability value sets with the target coherence type.
